(19) United States
(12) Patent Application Publication
(10) Pub. No.: US 2017/0018020 A1
(43) Pub. Date: Jan. 19, 2017

(54) INFORMATION PROCESSING APPARATUS AND METHOD AND NON-TRANSITORY COMPUTER READABLE MEDIUM

(71) Applicant: FUJI XEROX CO., LTD., Tokyo (JP)

(72) Inventors: Bin ZHOU, Kanagawa (JP); Bing YAN, Kanagawa (JP)

(73) Assignee: FUJI XEROX CO., LTD., Tokyo (JP)

(21) Appl. No.: 15/015,267

(22) Filed: Feb. 4, 2016

(30) Foreign Application Priority Data
Jul. 15, 2015 (JP) 2015-141485

(51) Int. Cl. G06Q 30/06; G06F 19/00

(52) U.S. Cl. CPC G06Q 30/0631; G06F 19/322

(57) ABSTRACT

An information processing apparatus includes the following elements. A medical record storage unit stores a medical record of a patient. A disease extracting unit extracts a name of a disease of the patient from the medical record. A complication information storage unit stores information concerning a complication related to the extracted name of the disease. A specialty disease storage unit stores a doctor and a name of a disease in which the doctor specializes in association with each other. A reviewer recommendation unit recommends a doctor specializing in a complication related to the extracted name of the disease as a medical record reviewer for the medical record of the patient.

### CROSS-REFERENCE TO RELATED APPLICATIONS

This application is based on and claims priority under 35 USC 119 from Japanese Patent Application No. 2015-141485 filed Jul. 15, 2015.

### BACKGROUND

### Technical Field

The present invention relates to an information processing apparatus and method and a non-transitory computer readable medium.

### SUMMARY

According to an aspect of the invention, there is provided an information processing apparatus including the following elements. A medical record storage unit stores a medical record of a patient. A disease extracting unit extracts a name of a disease of the patient from the medical record. A complication information storage unit stores information concerning a complication related to the extracted name of the disease. A specialty disease storage unit stores a doctor and a name of a disease in which the doctor specializes in association with each other. A reviewer recommendation unit recommends a doctor specializing in a complication related to the extracted name of the disease as a medical record reviewer for the medical record of the patient.

### BRIEF DESCRIPTION OF THE DRAWINGS

Exemplary embodiments of the present invention will be described in detail based on the following figures, wherein:

FIG. 1 is a block diagram of conceptual modules forming an example of the configuration of a first exemplary embodiment of the invention;

FIG. 2 illustrates an example of the configuration of a system utilizing one of exemplary embodiments of the invention;

FIG. 3 is a flowchart illustrating an example of processing according to the first exemplary embodiment;

FIG. 4 illustrates an example of the data structure of a medical record table;

FIG. 5 illustrates an example of the data structure of a patient-disease association table;

FIG. 6 illustrates an example of the data structure of a disease table;

FIG. 7 illustrates an example of the data structure of a complication table;

FIG. 8 illustrates an example of the data structure of a medical-record review execution status table;

FIG. 9 illustrates an example of the data structure of a doctor's specialty disease table;

FIG. 10 is a block diagram of conceptual modules forming an example of the configuration of a second exemplary embodiment of the invention;

FIG. 11 is a flowchart illustrating an example of processing according to the second exemplary embodiment;

FIG. 12 illustrates an example of the data structure of a medical-record review execution status table;

FIG. 13 illustrates an example of the data structure of a doctor's specialty disease table; and

FIG. 14 is a block diagram illustrating an example of the hardware configuration of a computer implementing exemplary embodiments of the invention.

### DETAILED DESCRIPTION

Exemplary embodiments of the invention will be described below with reference to the accompanying drawings.

### First Embodiment

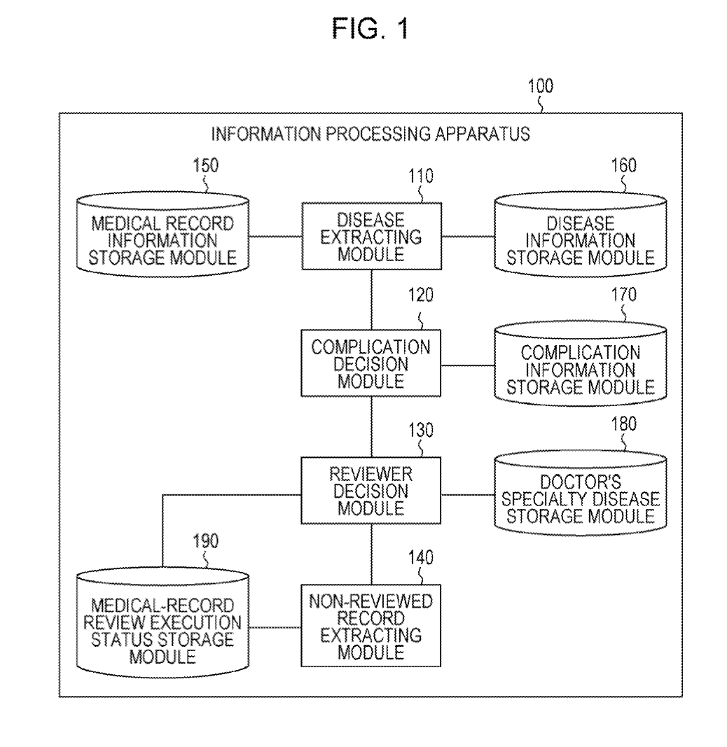

FIG. 1 is a block diagram of conceptual modules forming an example of the configuration of a first exemplary embodiment of the invention.

Generally, modules are software (computer programs) components or hardware components that can be logically separated from one another. Accordingly, the modules of the exemplary embodiments of the invention are not only modules of a computer program, but also modules of a hardware configuration. Thus, the exemplary embodiments will also be described in the form of a computer program for allowing a computer to function as those modules program for causing a computer to execute program steps, a program for allowing a computer to function as corresponding units, or a computer program for allowing a computer to implement corresponding functions), a system, and a method. While expressions such as “store”, “storing”, “being stored”, and equivalents thereof are used for the sake of description, such expressions indicate, when the exemplary embodiments relate to a computer program, storing the computer program in a storage device or performing control so that the computer program is stored in a storage device. Modules may correspond to functions based on a one-to-one relationship. In terms of implementation, however, one module may be constituted by one program, or plural modules may be constituted by one program. Conversely, one module may be constituted by plural programs. Additionally, plural modules may be executed by using a single computer, or one module may be executed by using plural computers in a distributed or parallel environment. One module may integrate another module therein. Hereinafter, the term “connection” includes not only physical connection, but also logical connection (sending and receiving of data, giving instructions, reference relationships among data elements, etc.). The term “predetermined” means being determined prior to a certain operation and includes the meaning of being determined prior to a certain operation before starting processing of the exemplary embodiments, and also includes the meaning of being determined prior to a certain operation even after starting processing of the exemplary embodiments, in accordance with the current situation/state or in accordance with the previous situation/state. If there are plural “predetermined values”, they may be different values, or two or more of the values (or ail the values) may be the same. A description having the meaning “in the case of A, B is performed” is used as the meaning “it is determined whether the case A is satisfied, and B is performed if it is determined that the case A is satisfied”, unless such a determination is unnecessary.

A system or an apparatus may be realized by connecting plural computers, hardware units, devices, etc., to one another via a communication medium, such as a network (including communication based on a one-to-one correspondence), or may be realized by a single computer, hardware unit, device, etc. The terms “apparatus” and “system” are used synonymously. The term “system” does not include merely a man-made social “mechanism” (social system).

Additionally, every time an operation is performed by using a corresponding module or every time each of plural operations is performed by using a corresponding module, target information is read from a storage device, and after performing the operation, a processed result is written into the storage device. Accordingly, a description of reading from the storage device before an operation or writing into the storage device after an operation may be omitted. Examples of the storage device may be a hard disk (HD), a random access memory (RAM), an external storage medium, a storage device using a communication line, a register within a central processing unit (CPU), etc.

An information processing apparatus 100, which is the first exemplary embodiment of the invention, is used for assisting qualitative auditing for ensuring the quality of diagnosis in a medical institution. As shown in FIG. 1, the information processing apparatus 100 includes a disease extracting module 110, a complication decision module 120, a reviewer decision module 130, a non-reviewed record extracting module 140, a medical record information storage module 150, a disease information storage module 160, a complication information storage module 170, a doctor's specialty disease storage module 180, and a medical-record review execution status storage module 190.

In a medical institution, quantitative auditing and qualitative auditing are conducted for medical records. Auditing includes external auditing performed by an external organization and internal auditing performed by an internal organization on a regular basis. The information processing apparatus 100 is principally used when qualitative auditing is performed within a medical institution.

(1) Quantitative auditing is principally performed by health information managers to check whether or not necessary documents have been created and registered at appropriate times and whether or not consent documents to medical care obtained from patients are registered.

(2) Qualitative auditing is conducted to check the content of diagnosis and is principally performed by doctors because special expertise is required. Items to be checked include whether or not the basis (ground) for performing certain medical care is described, whether or not the reason (the name of a disease) why a certain prescription drug has been, selected is described, and whether or not sufficient study has been carried out to diagnose a certain disease.

The disease extracting module 110 is connected to the complication decision module 120, the medical record information storage module 150, and the disease information storage module 160. The disease extracting module 110 extracts the name of a disease of a certain patient from medical records within the medical record information storage module 150. More specifically, the disease extracting module 110 extracts a document (document ID field 415) to be audited by using an auditing subject field 425 of a medical record table 400, and then extracts a patient (patient ID field 405) associated with the extracted document. Then, by using a patient-disease association table 500, the disease extracting module 110 extracts a disease ID (disease ID field 510) of the extracted patient (patient ID field 505).

Alternatively, by using the medical record table 400, the disease extracting module 110 may extract the name of a disease from a document to be audited, and may then extract a disease ID (disease ID 605) from the name of the disease by using a disease table 600.

The complication decision module 120 is connected to the disease extracting module 110, the reviewer decision module 130, and the complication information storage module 170. The complication decision module 120 determines a complication related to a disease extracted by the disease extracting module 110 by using the complication information storage module 170. More specifically, by using a complication table 700, the complication decision module 120 determines a complication which may appear from a disease extracted by the disease extracting module 110 described in a document to be audited.

The reviewer decision module 130 is connected to the complication decision module 120, the non-reviewed record extracting module 140, the doctor's specialty disease storage module 180, and the medical-record review execution status storage module 190. The reviewer decision module 130 recommends a doctor who specializes in a complication related to a disease extracted by the disease extracting module 110 as a medical record reviewer for a medical record of a certain patient. In this case, the recommendation of a doctor may be performed by displaying information concerning a specialist, for example, a doctor (for example, the name, clinical department, job title, and face photo) as a medical record reviewer on a display device, such as a liquid crystal display, or by outputting such information from a speaker as voice sound. As a document for which a medical record reviewer has not been decided, a document extracted by the non-reviewed record extracting module 140 is used.

The reviewer decision module 130 may recommend a doctor who is not a document creator and who specializes in a complication related to a disease extracted by the disease extracting module 110 as a medical record reviewer. Alternatively, the reviewer decision module 130 may recommend a doctor who can handle both of a subject disease and a complication related to this subject disease as a medical record reviewer.

The reviewer decision module 130 may recommend a doctor having a higher experience point as a medical record reviewer. Details of the experience point will be discussed later.

The reviewer decision module 130 may display plural candidate doctors as medical record reviewers so as to let a user select a medical reviewer from among the candidate doctors.

The non-reviewed record extracting module 140 is connected to the reviewer decision module 130 and the medical-record review execution status storage module 190. The non-reviewed record extracting module 140 extracts a medical record for which a medical record reviewer has not been decided from the medical-record review execution status storage module 190. More specifically, by using a medical-record review execution status table 800 within the medical-record review execution status storage module 190, the non-reviewed record extracting module 140 extracts a document (document ID field 805) corresponding to a reviewer field 815 which is blank (or information indicating that a medical record reviewer has not been decided).

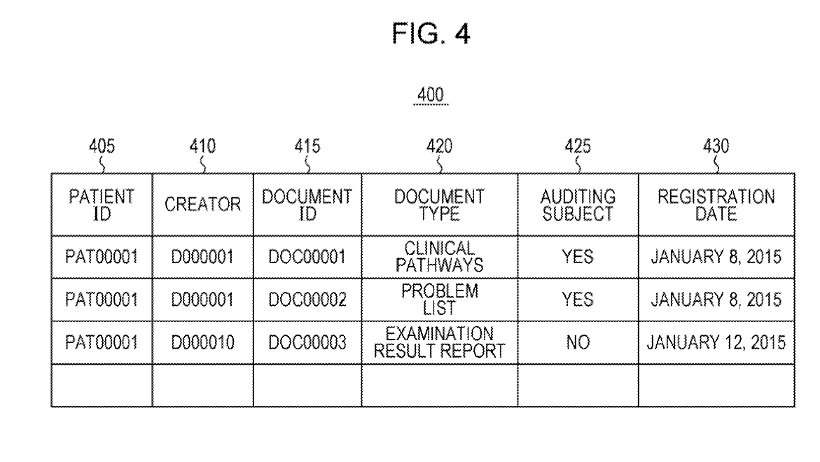

The medical record information storage module 150 is connected to the disease extracting module 110. The medical record information storage module 150 stores patients' medical records therein. That is, the medical record information storage module 150 stores medical record information concerning medical records to be subjected to qualitative auditing. The medical record information storage module 150 stores, for example, the medical record table 400 and the patient-disease association table 500. FIG. 4 illustrates an example of the data structure of the medical record table 400. The medical record table 400 includes a patient ID field 405, a creator field 410, a document ID field 415, a document type field 420, an auditing subject field 425, and a registration date field 430. In the patient ID field 405, information (patient identification (ID)) for uniquely identifying a patient in the exemplary embodiments is stored. In the creator field 410, information (creator ID) for uniquely identifying a creator of a document, which is a medical record of a patient, in the exemplary embodiments, is stored. In the document ID field 415, information (document ID) for uniquely identifying a document in the exemplary embodiments is stored. In the document type field 420, the document type of document is stored. In the auditing subject field 425, information (YES or NO) concerning whether or not a document is a subject to be audited is stored. In the registration date field 430, the registration date of a document is stored.

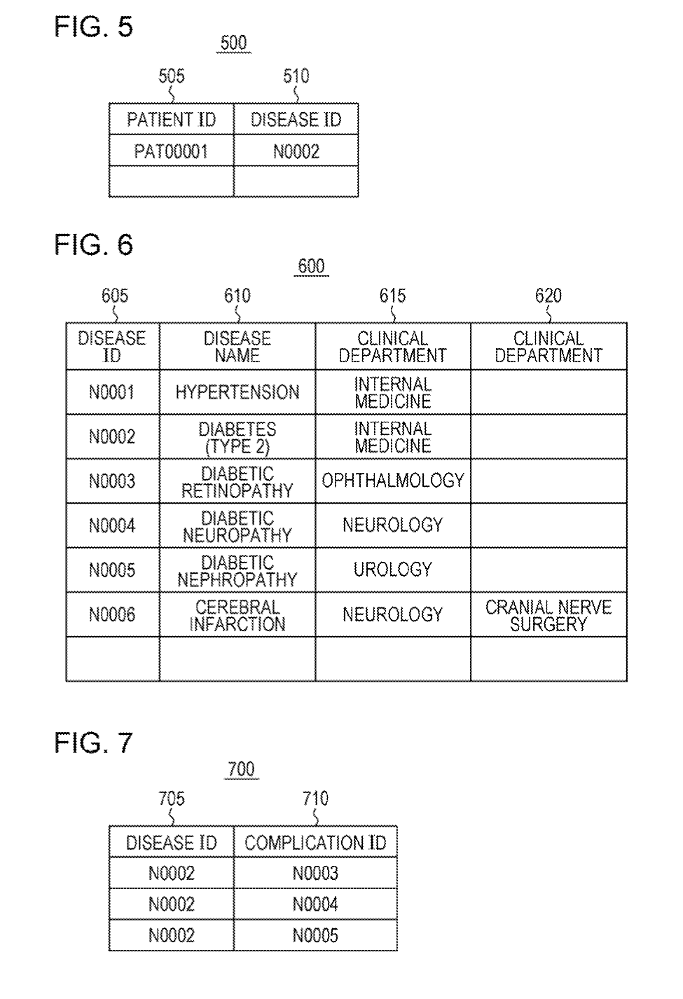

FIG. 5 illustrates an example of the data structure of the patient-disease association table 500. The patient-disease association table 500 includes a patient ID field 505 and a disease ID field 510. In the patient ID field 505, a patient ID is stored. In the disease ID 510, information (disease ID) for uniquely identifying the disease of a patient represented by the patient ID in the exemplary embodiments is stored.

The disease information storage module 160 is connected to the disease extracting module 110. The disease information storage module 160 stores the names of diseases described in medical records. The disease information storage module 160 stores, for example, the disease table 600. FIG. 6 illustrates an example of the data structure of the disease table 600. The disease table 600 includes a disease ID field 605, a disease name field 610, and clinical department fields 615 and 620. In the disease ID field 605, a disease ID is stored. In the disease name field 610, the name of a disease represented by the disease ID is stored. In the clinical department fields 615 and 620, a clinical department of a disease indicated by the disease name is stored. Concerning at clinical department field, only one field or three or more fields may be provided.

The complication information storage module 170 is connected to the complication decision module 120. The complication information storage module 170 stores complication information concerning complications related to a certain disease. That is, the complication information storage module 170 stores complication information concerning complications related to a disease extracted by the disease extracting module 110. Complications related to a disease are complications that may accompany this disease. The complication information storage module 170 stores, for example, the complication table 700. FIG. 7 illustrates an example of the data structure of the complication table 700. The complication table 700 includes a disease ID field 705 and a complication ID field 710. In the disease ID field 705, a disease ID is stored. In the complication ID field 710, a complication ID of a complication that may accompany a disease represented by the disease ID is stored.

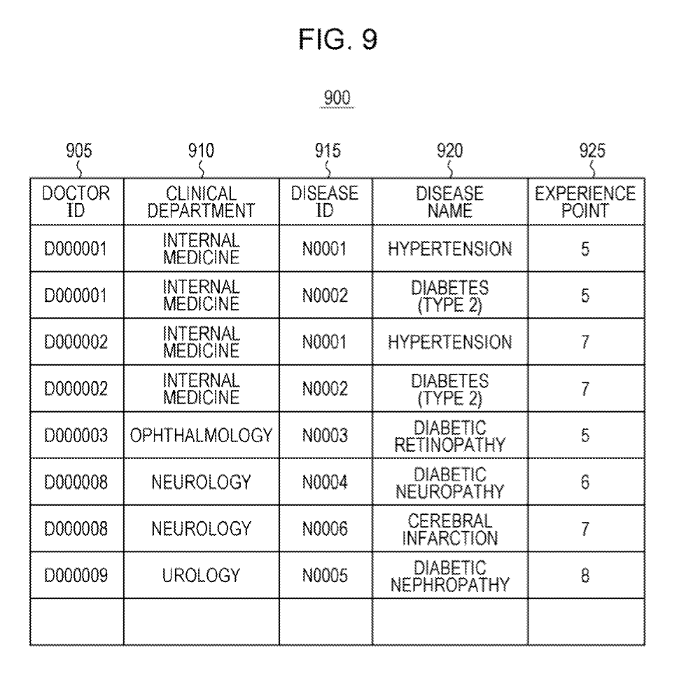

The doctor's specialty disease storage module 180 is connected to the reviewer decision module 130. The doctor's specialty disease storage module 180 stores doctor IDs and the names of diseases in which the doctors specialize in association with each other. The doctor's specialty disease storage module 180 stores, for example, a doctor's specialty disease table 900. FIG. 9 illustrates an example of the data structure of the doctor's specialty disease table 900. The doctor's specialty disease table 900 includes a doctor ID field 905, a clinical department field 910, a disease ID field 915, a disease name field 920, and an experience point field 925. In the doctor ID field 905, information (doctor ID) for uniquely identifying a doctor in the exemplary embodiments is stored. In the clinical department field 910, a clinical department to which a doctor represented by the doctor ID belongs is stored. In the disease ID field 915, the disease ID of a disease for which a doctor has enough experience is stored. In the disease name field 920, the name of a disease represented by the disease ID is stored. In the experience point field 925, the experience point (in this case, the years, of experience) given to a doctor represented by the doctor ID concerning a disease represented by the disease ID is stored.

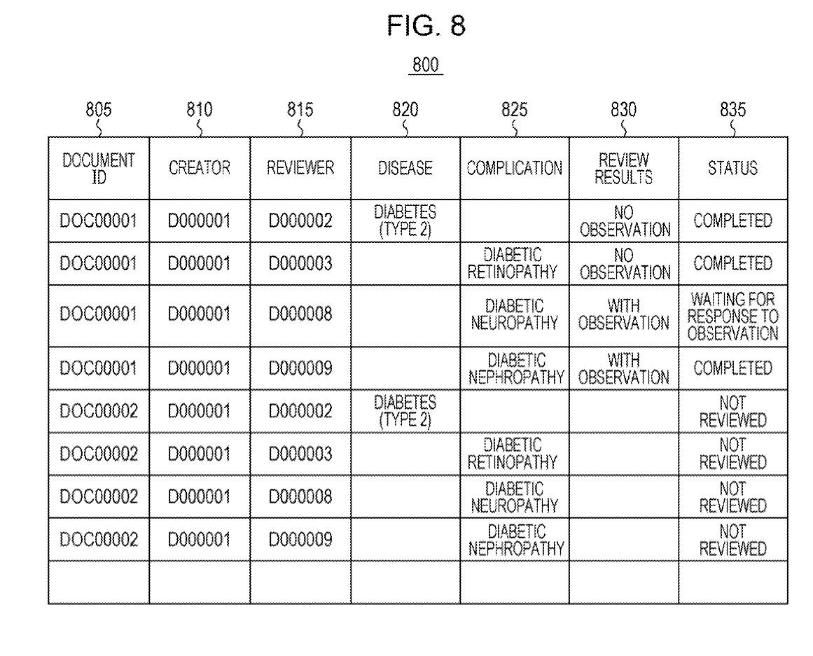

The medical-record review execution status storage module 190 is connected to the reviewer decision module 130 and the non-reviewed record extracting module 140. The medical-record review execution status storage module 190 stores information concerning, for example, the review execution progress and reviewers of individual medical records. That is, the medical-record review execution status storage module 190 stores results of executing reviews by medical record reviewers. The medical-record review execution status storage module 190 stores, for example, the medical-record review execution status table 800. FIG. 8 illustrates an example of the data structure of the medical-record review execution status table 800. The medical-record review execution status table 800 includes a document ID field 805, a creator field 810, a reviewer field 815, a disease field 820, a complication field 825, a review result field 830, and a status field 835. In the document ID field 805, a document ID is stored. In the creator field 810, a creator of a document represented by the document ID is stored. In the reviewer field 815, a medical record reviewer for a document represented by the document ID is stored. In the disease field 820, a disease described in a document represented by the document ID is stored. In the complication field 825, a complication related to a disease indicated in the disease field 820 is stored. In the review result field 830, a review result for a document represented by the document ID is stored. Specifically, as the review result (audit result), “with observation” or “no observation” is indicated. In the status field 835, the status of auditing for a document represented by the document ID is stored. Specifically, as the status of auditing, “completed”, “not reviewed (not audited)”, or “waiting for response to observation” is indicated.

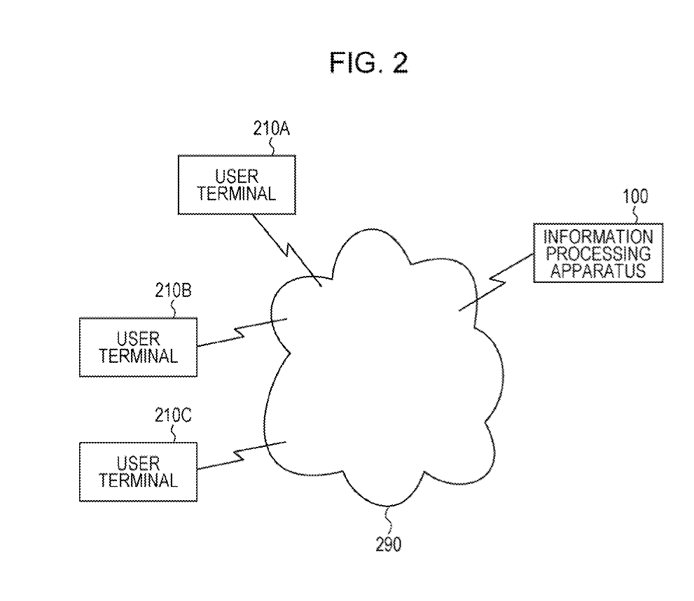

FIG. 2 illustrates an example of the configuration of a system utilizing one of the exemplary embodiments. The system shown in FIG. 2 includes the information processing apparatus 100 and user terminals 210 (210A, 210B, and 210C) which cause the information processing apparatus 100 to perform processing.

The information processing apparatus 100 and the user terminals 210A, 210B, and 210C are connected to one another via a communication network 290. The communication network 290 may be a wireless or wired medium, or a combination thereof, and may be, for example, the Internet or an intranet as a communication infrastructure. The functions of the information processing apparatus 100 may be implemented as cloud services. The user terminals 210 are principally operated by medical practitioners, such as doctors. For example, as the assistance for qualitative auditing, a medical record reviewer is recommended for a medical record created by using a user terminal 110.

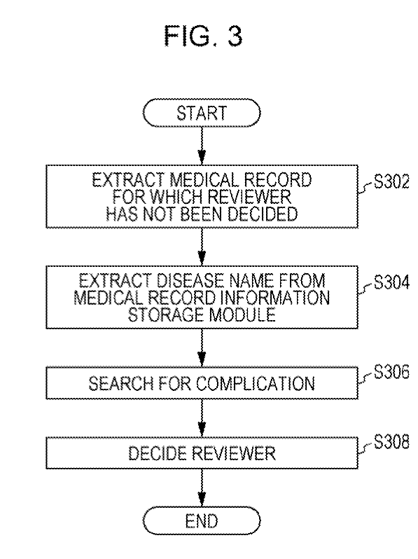

FIG. 3 is a flowchart illustrating an example of processing according to the first exemplary embodiment.

In step S302, the non-reviewed record extracting module 140 extracts a medical record for which a reviewer has not been decided (document for which a medical record reviewer has not been decided) from the medical-record review execution status storage module 190.

In step S304, the disease extracting module 110 extracts the name of a disease described in the medical record extracted in step S302 from the medical record in format ion storage module 150.

In step S306, the complication decision module 120 searches for a complication related to the disease extracted in step S304 from the complication information storage module 170.

In step S308, the reviewer decision module 130 decides a medical record reviewer for the complication extracted in step S306 by using the doctor's specialty disease storage module 180.

The above-described processing will be described specifically by taking a diabetes patient (PAT00001) in the hospital as an example by using the medical record table 400, the patient-disease association table 500, the disease table 600, the complication table 700, the medical-record review execution status table 800, and the doctor's specialty disease table 900 respectively shown in FIGS. 4 through 9.

The medical record table 400 shows that, as medical records of this patient (PAT00001), three documents (DOC00001, DOC00002, DOC00003) are registered. Among these three documents, documents to be subjected to auditing (“YES” in the auditing subject field 425) are two documents (DOC00001, DOC00002).

The name of the disease of this patient described in the two documents is extracted as “diabetes” from the description in the documents or from the patient-disease association table 500.

Then, complications related to the extracted name of the disease (diabetes) are searched for from the complication table 700, and “diabetic retinopathy (N0003)”, “diabetic neuropathy (N0004)”, “diabetic nephropathy (N0005)” are extracted. Then, it is decided that medical record reviews by a medical specialist are also required for medical records concerning these complications, as well as concerning diabetes (N0002). The names of diseases may be extracted from the disease IDs (complication IDs) by using the disease table 600.

Then, a medical record reviewer is recommended for medical records for which medical record reviews are necessary. For example, a doctor who satisfies all the following conditions may be extracted by using a search formula “(condition 1-1) AND (condition 1-2) AND (condition 1-3)” and be decided as a medical record reviewer:

condition 1-1: doctors other than a document creator;

condition 1-2: medical specialists in complications related to a subject disease; and

condition 1-3: a doctor having the highest experience point (experience point field 925 in the doctor's specialty disease table 900) among the candidate doctors who satisfy (condition 1-1) AND (condition 1-2).

Alternatively, candidate doctors satisfying (condition 1-1) AND (condition 1-2) may be presented to let a user choose one from the candidate doctors.

As the condition 1-1, a doctor other than a document creator and belonging to a clinical department other than that to which the document creator belongs may be set. In this manner, a doctor who does not have hierarchical relations with the document creator may be selected.

A management method for the execution status of medical record reviews will be described by using the medical-record review execution status table 800. By using the medical-record review execution status table 800, the progress of the review execution and improvements concerning observations (review result field 830 and status field 835) are managed for documents for which medical record reviews are required.

For deciding a medical record reviewer for a document on the basis of the name of a disease and the experience point (condition 1-3), the doctor's specialty disease table 900 is used. The experience point (experience point field 925) is preset based on, for example, the years of occupation as a doctor and the years since a medical qualification has been obtained.

### Second Exemplary Embodiment

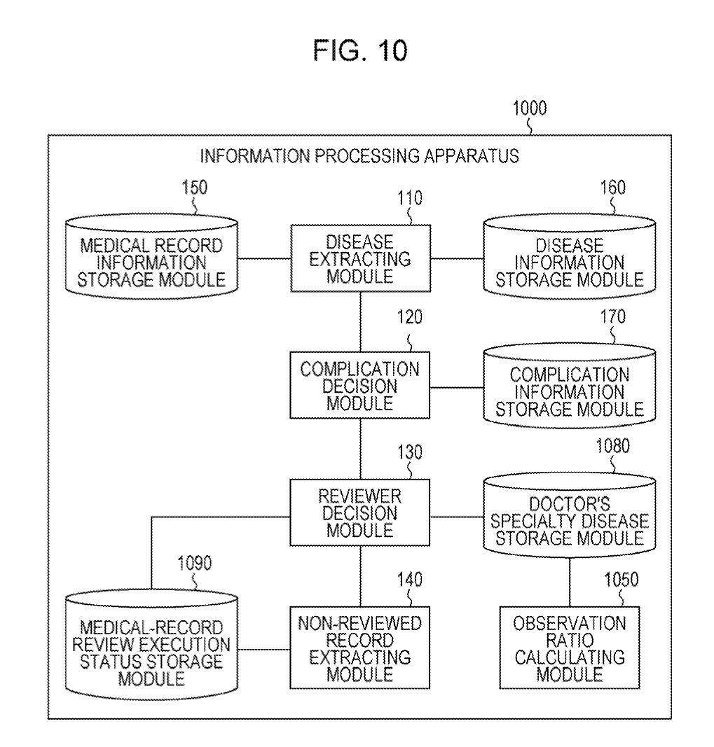

FIG. 10 is a block diagram of conceptual modules forming an example of the configuration of an information processing apparatus 1000 of a second exemplary embodiment of the invention. The information processing apparatus 1000 decides a medical record reviewer by using past track records of reviews. The information processing apparatus 1000 includes a disease extracting module 110, a complication decision module 120, a reviewer decision module 130, a non-reviewed record extracting module 140, a medical record information storage module 150, a disease information storage module 160, a complication information storage module 170, a doctor's specialty disease storage module 1080, a medical-record review execution status storage module 1090, and an observation ratio calculating module 1050. Elements similar to those of the first exemplary embodiment are designated by like reference numerals, and an explanation thereof will thus be omitted.

The disease extracting module 110 is connected to the complication decision module 120, the medical record information storage module 150, and the disease information storage module 160.

The complication decision module 120 is connected to the disease extracting module 110, the reviewer decision module 130, and the complication information storage module 170.

The reviewer decision module 130 is connected to the complication decision module 120, the non-reviewed record extracting module 140, the doctor's specialty disease storage module 1080, and the medical-record review execution status storage module 1090.

The non-reviewed record extracting module 140 is connected to the reviewer decision module 130 and the medical-record review execution status storage module 1090.

The medical record information storage module 150 is connected to the disease extracting module 110.

The disease information storage module 160 is connected to the disease extracting module 110.

The complication information storage module 170 is connected to the complication decision module 120.

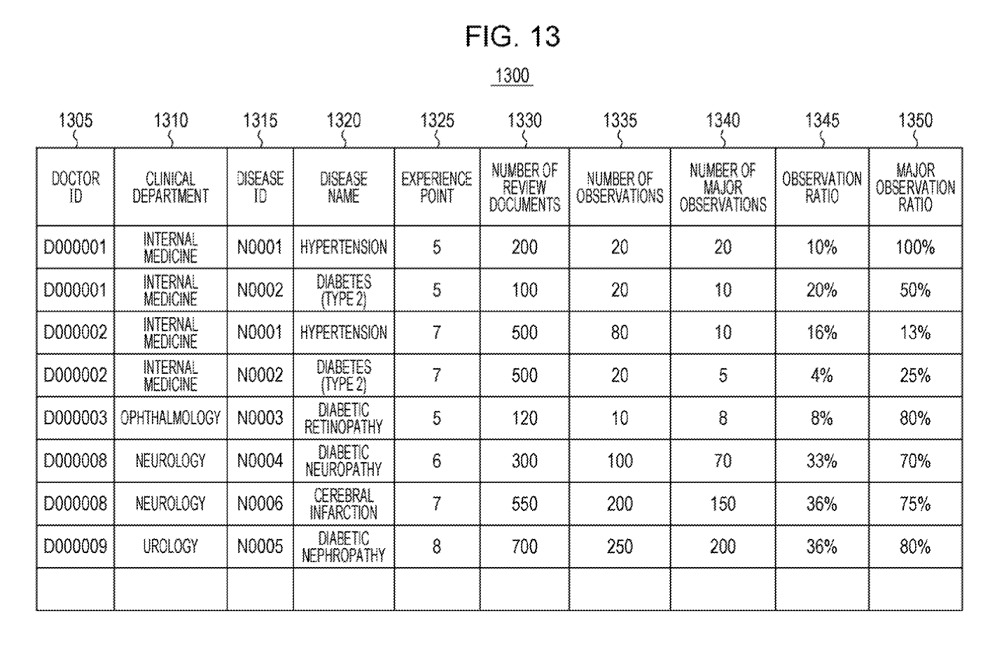

The doctor's specialty disease storage module 1080 is connected to the reviewer decision module 130 and the observation ratio calculating module 1050. The doctor's specialty disease storage module 1080 stores the observation ratio and the major observation ratio within a predetermined period (for example, within the previous year) in addition to the content of the doctor's specialty disease storage module 180 of the first exemplary embodiment. The doctor's specialty disease storage module 1080 stores, for example, a doctor's specialty disease table 1300. FIG. 13 illustrates an example of the data structure of the doctor's specialty disease table 1300. The doctor's specialty disease table 1300 is a table in which a number-of-review-documents field 1330, a number-of-observations field 1335, a number-of-major-observations field 1340, an observation ratio field 1345, and a major observation ratio field 1350 are added to the fields of the doctor's specialty disease table 900 shown in FIG. 9. That is, the doctor's specialty disease table 1300 includes a doctor ID field 1305, a clinical department field 1310, a disease ID field 1315, a disease name field 1320, an experience point field 1325, the number-of-review-documents field 1330, the number-of-observations field 1335, the number-of-major-observations field 1340, the observation ratio field 1345, and the major observation ratio field 1350. In the doctor ID field 1305, a doctor ID is stored. In the clinical department field 1310, a clinical department to which a doctor represented by the doctor ID belongs is stored. In the disease ID field 1315, the disease ID of a disease for which a doctor has enough experience is stored. In the disease name field 1320, the name of a disease represented by the disease ID is stored. In the experience point field 1325, the experience point (in this case, the years of experience) given to a doctor represented by the doctor ID concerning a disease represented by the disease ID is stored. In the number-of-review-documents field 1330, the number of documents reviewed for a disease represented by the disease ID by a doctor represented by the doctor ID is stored. In the number-of-observations field 1335, the number of observations in reviews made for a disease represented by the disease ID by a doctor represented by the doctor ID is stored. In the number-of-major-observations field 1340, the number of major observations in reviews made for a disease represented by the disease ID by a doctor represented by the doctor ID is stored. In the observation ratio field 1345, the observation ratio, which is a ratio of the number of observations (number-of-observations field 1335 to the number of review documents (number-of-review-documents field 1330), is stored. That is, the observation ration (observation ratio=the number of observation/the number of review documents) may be an index indicating how many deficiencies have been found. In the major observation ratio field 1350, the major observation ratio, which is a ratio of the number of major observations (number-of-major-observations field 1340) to the number of observations (number-of-observations field 1335), is stored. That is, the major observation ratio (major observation ratio the number of major observations/the number of observations) may be an index indicating how many major observations have been pointed out. The values in the observation ratio field 1345 and the major observation ratio field 1350 are calculated by the observation ratio calculating module 1050.

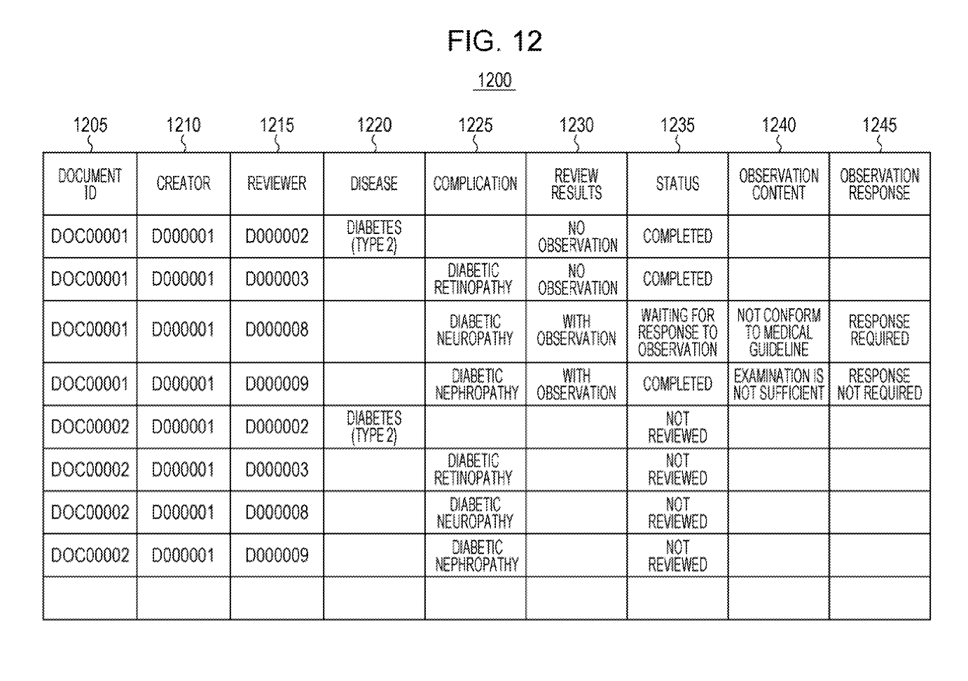

The medical-record review execution status storage module 1090 is connected to the reviewer decision module 130 and the non-reviewed record extracting module 140. In the medical-record review execution status storage module 1090, the type (content) of observation made by a medical record reviewer and information indicating whether or not it is necessary to respond to the observation are stored in addition to the content of the medical-record review execution status storage module 190 of the first exemplary embodiment. More specifically, when an observation is made for a document as a result of reviewing, a summary of the content of the observation and information indicating whether or net it is necessary to respond to the observation is stored. The medical-record review execution status storage module 1090 may also include a result of examining a reviewer's observation by a document creator. The medical-record review execution status storage module 1090 stores, for example, a medical-record review execution status table 1200. FIG. 12 illustrates an example of the data structure of the medical-record review execution status table 1200. The medical-record review execution status table 1200 is a table in which an observation content field 1240 and an observation response field 1245 are added to the medical-record review execution status table 800 shown in FIG. 8. That is, the medical-record review execution status table 1200 includes a document ID field 1205, a creator field 1210, a reviewer field 1215, a disease field 1220, a complication field 1225, a review result field 1230, a status field 1235, the observation content field 1240, and the observation response field 1245. In the document ID field 1205, a document ID is stored. In the creator field 1210, a creator of a document represented by the document ID is stored. In the reviewer field 1215 a medical record reviewer for a document represented by the document ID is stored. In the disease field 1220, a disease described in a document represented by the document ID is stored. In the complication field 1225, a complication related to a disease indicated in the disease field 1220 is stored. In the review result field 1230, a review result for a document represented by the document ID is stored. Specifically, as the review result (audit result), “with observation” or “no observation” is indicated. In the status field 1235, the status ox auditing for a document represented by the document ID is stored. Specifically, as the status of auditing, “completed”, “not reviewed (not audited)”, or “waiting for response to observation” is indicated. In the observation content field 1240, the observation content for a review (more specifically, for example, “not conform to medical guideline” and “examination is not sufficient”) is stored. In the observation response field 1245, information indicating whether or not it is necessary to respond to the observation (more specifically, for example, “response required” or “response not required”) is stored.

The observation ratio calculating module 1050 is connected to the doctor's specialty disease storage module 1080. The observation ratio calculating module 1050 evaluates the observation ratio concerning observations made by a doctor. More specifically, the observation ratio calculating module 1050 calculates values to be stored in the observation ratio field 1345 and in the major observation ratio field 1350 of the doctor's specialty disease table 1300.

The reviewer decision module 130 decides a doctor to be recommended as a medical record reviewer in accordance with the evaluation result determined by the observation ratio calculating module 1050. More specifically, plural doctors for which the value of the number-of-review-documents field 1330, the number-of-observations field 1335, the number-of-major-observations field 1340, the observation ratio field 1345, or the major observation ratio field 1350 is higher than a predetermined threshold may be selected. Alternatively, the values of the selected doctors may be sorted in descending order, and plural doctors within predetermined ranks may be selected.

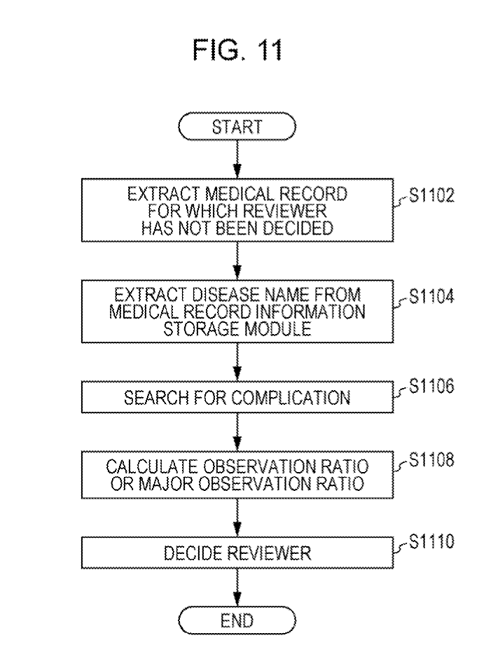

FIG. 11 is a flowchart illustrating an example of processing according to the second exemplary embodiment. In the processing shown in the flowchart of FIG. 11, step S1108 is added between steps S306 and S308 in the flowchart of FIG. 3.

In step S1102, the non-reviewed record extracting module 140 extracts a medical record for which a reviewer has not been decided.

In step S1104, the disease extracting module 110 extracts the name of a disease described in the medical record extracted in step S1102 from the medical record information storage module 150.

In step S1106, the complication decision module 120 searches for a complication related to the disease extracted in step S1104.

In step S1108, the observation ratio calculating module 1050 calculates the observation ratio or the major observation ratio.

In step S1110, the reviewer decision module 130 decides a reviewer by using the observation ratio or the major observation ratio calculated in step S1108.

In the second embodiment, the decision of a medical record reviewer by the reviewer decision module 130 may be performed by using one of the following decision approaches.

Decision Approach (1)

A doctor satisfying all the following conditions; is selected by using a search formula “(condition 2-1) AND (condition 2-2) AND (condition 2-3)”:

condition 2-1: doctors other than a document creator;

condition 2-2: medical specialists in complications related to a subject disease; and

condition 2-3: a doctor having the largest number of observations (number-of-observations field 1335 in the doctor's specialty disease table 1300) among the candidate doctors who satisfy (condition 2-1) AND (condition 2-2).

Decision Approach (2)

A doctor having the highest observation ratio (observation ratio field 1345 in the doctor's specialty disease table 1300) among the candidate doctors who satisfy (condition 2-1) AND (condition 2-2) is selected.

Decision Approach (3)

A doctor having the highest major observation ratio (major observation ratio field 1350 in the doctor's specialty disease table 1300) among the candidate doctors who satisfy (condition 2-1) AND (condition 2-2) is selected.

Decision Approach (4)

Candidate doctors who satisfy (condition 2-1) AND (condition 2-2) and at least one of the number of review documents (number-of-review-documents field 1330), the number of observations (number-of-observations field 1335), the number of major observations (number-of-major-observations field 1340), the observation ratio (observation ratio field 1345), and the major observation ratio (major observation ratio field 1350) are presented to let a user choose one from the candidate doctors.

Decision Approach (5)

A doctor having the largest number of review documents (number-of-review-documents field 1330 in the doctor's specialty disease table 1300) among the candidate doctors who satisfy (condition 2-1) AND (condition 2-2) is selected.

Decision Approach (6)

A doctor having the largest number of major observations (number-of-major-observations field 1340 in the doctor's specialty disease table 1300) among the candidate doctors who satisfy (condition 2-1) AND (condition 2-2) is selected.

In the above-described decision approaches, the doctor having the “largest number” or “highest ratio” is selected. However, as described before, plural doctors for which the value of the ratio or the number higher than a predetermined threshold may be selected. Alternatively, the values of the selected doctors may be sorted in descending order, and plural doctors within predetermined ranks may be selected.

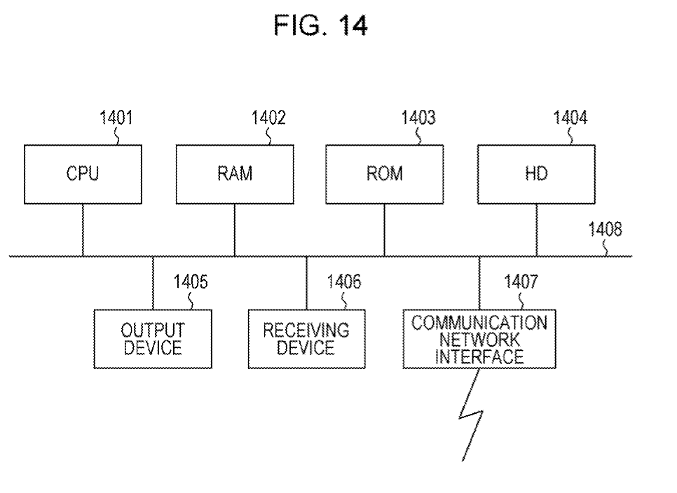

The hardware configuration of a computer in which a program serving as the exemplary embodiments of the invention is executed is a general computer, such as a personal computer (PC) or a server, as shown in FIG. 14. More specifically, such a computer uses a CPU 1401 as a processor (operation unit) and a RAM 1402, a read only memory (ROM) 1403, and a hard disk (HD) 1404 as storage devices. As the HD 1404, a hard disk or a solid state drive (SSD) may be used. The computer includes the CPU 1401, the RAM 1402, the ROM 1403, the HD 1404, such as an auxiliary storage device (may alternatively be a flash memory, an output device 1405, such as a cathode ray tube (CRT), a liquid crystal display, and a speaker, a receiving device 1406, a communication network interface 1407, and a bus 1408. The CPU 1401 executes a program, such as the disease extracting module 110, the complication decision module 120, the reviewer decision module 130, the non-reviewed record extracting module 140, and the observation ratio calculating module 1050. The RAM 1402 stores this program and data therein. The ROM 1403 stores a program for starting the computer. The HD 1404 has functions as the medical record information storage module 150, the disease information storage module 160, the complication information storage module 170, the doctor's specialty disease storage module 180, the medical-record review execution status storage module 190, and the doctor's specialty disease storage module 1080. The receiving device 1406 receives data on the basis of an operation performed by a user on a keyboard, a mouse, a touch panel, or a microphone. The communication network interface 1407 is, for example, a network interface card, for communicating with a communication network. The above-described elements are connected to one another via the bus 1408 and send and receive data to and from one another. The above-described computer may be connected to another computer configured similarly to this computer via a network.

In the above-described exemplary embodiments, concerning an element implemented by a computer program, such a computer program, which is software, is read into a system having the system configuration shown in FIG. 14, and the above-described exemplary embodiments are implemented in a cooperation of software and hardware resources.

The hardware configuration shown in FIG. 14 is only an example, and the exemplary embodiments may be configured in any manner as long as the modules described in the exemplary embodiments are executable. For example, some modules may be configured as dedicated hardware (for example, an application specific integrated circuit (ASIC)), or some modules may be installed in an external system and be connected to the PC via a communication line. Alternatively, a system, such as that shown in FIG. 14, may be connected to a system, such as that shown in FIG. 14, via a communication line, and may be operated in cooperation with each other. Additionally, instead of into a PC, the modules may be integrated into a mobile information communication device (including a cellular phone, a smartphone, a mobile device, and a wearable computer), a home information appliance, a robot, a copying machine, a fax machine, a scanner, a printer, or a multifunction device (image processing apparatus including two or more functions among a scanner, a printer, a copying machine, and a fax machine).

In the above-described exemplary embodiments, when comparing a certain value with a predetermined value, “equal to or greater than”, “equal to or smaller than”, “greater than”, and “smaller than” may also be read as “greater than”, “smaller than”, “equal to or greater than”, and “equal to or smaller than”, respectively, unless there is an inconsistency between a combination of two values to be compared.

The above-described program may be stored in a recording medium and be provided. The program recorded on a recording medium may be provided via a communication medium. In this case, the above-described program may be implemented as a “non-transitory computer readable medium storing the program therein” in the exemplary embodiments of the invention.

The “non-transitory computer readable medium storing a program therein” is at recording medium storing a program therein that can be read by a computer, and is used for installing, executing, and distributing the program.

Examples of the recording medium are digital versatile disks (DVDs), and more specifically, DVDs standardized by the DVD Forum, such as DVD-R, DVD-RW, and DVD-RAM, DVDs standardized by the DVD+RW Alliance, such as DVD+R and DVD+RW, compact discs (CDs), and more specifically, a read only memory (CD-ROM), a CD recordable (CD-R), and a CD rewritable (CD-RW), Blu-ray disc (registered trademark), a magneto-optical disk (MO), a flexible disk (FD), magnetic tape, a hard disk, a ROM, an electrically erasable programmable read only memory (EEPROM) (registered trademark), a flash memory, a RAM, a secure digital (SD) memory card, etc.

The entirety or part of the above-described program may be recorded on such a recording medium and stored therein or distributed. Alternatively, the entirety of part of the program may be transmitted through communication by using a transmission medium, such as a wired network used for a local area network (LAN), a metropolitan area network (MAN), a wide area network (WAN), the Internet, an intranet, or an extranet, a wireless communication network, or a combination of such networks. The program may be transmitted by using carrier waves.

The above-described program may be part of another program, or may be recorded, together with another program, on a recording medium. The program may be divided and recorded on plural recording media. Further, the program may be recorded in any form, for example, it may be compressed or encrypted, as long as it can be reconstructed.

The foregoing description of the exemplary embodiments of the present invention has been provided for the purposes of illustration and description, It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a medical record storage unit that stores a medical record of a patient;
a disease extracting unit that extracts a name of a disease of the patient from the medical record;
a complication information storage unit that stores information concerning a complication related to the extracted name of the disease;
a specialty disease storage unit that stores a doctor and a name of a disease in which the doctor specializes in association with each other; and
a reviewer recommendation unit that recommends a doctor specializing in a complication related to the extracted name of the disease as a medical record reviewer for the medical record of the patient.

2. The information processing apparatus according to claim 1, wherein the reviewer recommendation unit recommends, as the medical record reviewer, a doctor who is not a creator of a document concerning the medical record and who specializes in the complication related to the extracted name of the disease.

3. The information processing apparatus according to claim 2, wherein the reviewer recommendation unit recommends a doctor having a higher experience point as the medical record reviewer.

4. The information processing apparatus according to claim 1, further comprising:
an evaluation unit that evaluates an observation ratio of a doctor, which represents a ratio of the number of observations to the number of documents reviewed by the doctor,
wherein the reviewer recommendation unit decides a doctor to be recommended as the medical record reviewer in accordance with a result of evaluating the observation ratio by the evaluation unit.

5. The information processing apparatus according to claim 1, further comprising:
a selector that displays a plurality of candidate doctors as the medical record reviewer so as to let a user select a doctor from among the candidate doctors.

6. The information processing apparatus according to claim 1, further comprising:
a storage unit that stores a type of observation made by a medical record reviewer and information indicating whether or not it is necessary to respond to the observation,
wherein the storage unit stores a result of examining the observation by a creator of a document.

7. An information processing method comprising:
extracting a name of a disease of a patient from a medical record of the patient;
extracting information concerning a complication related to the extracted name of the disease; and
recommending a doctor specializing in the complication related to the extracted name of the disease as a medical record reviewer for the medical record of the patient.

8. A non-transitory computer readable medium storing a program causing a computer to execute a process, the process comprising:
extracting a name of a disease of a patient from a medical record of the patient;
extracting information concerning a complication related to the extracted name of the disease; and
recommending a doctor specializing in the complication related to the extracted name of the disease as a medical record reviewer for the medical record of the patient.
